(19) United States
(12) Patent Application Publication
(10) Pub. No.: US 2006/0291367 A1
(43) Pub. Date: Dec. 28, 2006

(54) ROM type optical recording medium

(75) Inventors: Hiroshi Takasaki, Tokyo (JP); Hisaji Oyake, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/185,787

(22) Filed: Jul. 21, 2005

(30) Foreign Application Priority Data
Jul. 21, 2004 (JP) 2004-212682

(51) Int. Cl. G11B 3/70; G11B 7/26

(52) U.S. Cl. 369/283; 369/288

(57) ABSTRACT

A ROM type optical recording medium 1 includes a substrate 2, a light transmitting layer 4, and a reflecting layer 3 formed between the substrate 2 and the light transmitting layer 4 and containing a metal as a principal component and has such a structure that a laser beam is irradiated through the light transmitting layer 4 to reproduce data. The reflecting layer 3 is formed on the substrate 2 and includes a second reflecting film 3a having nitrogen added thereto and a first reflecting film 3b formed on the second reflecting film 3a and having no nitrogen added thereto.

### BACKGROUND OF THE INVENTION

The present invention relates to a ROM type optical recording medium, and more particularly to a ROM type optical recording medium capable of effectively preventing the corrosion of a reflecting layer and capable of enhancing a reliability in case of storage and use for a long period of time.

Conventionally, optical recording media represented by a CD and a DVD have been utilized widely as recording media for recording digital data. These optical recording media can be roughly classified into ROM type optical recording media which can neither once write nor rewrite data, for example, a CD-ROM and a DVD-ROM, write-once optical recording media which can once write data but cannot rewrite data, for example, a CD-R and a DVD-R, and rewritable optical recording media capable of rewriting data, for example, a CD-RW and a DVD-RW.

In the ROM type optical recording medium, pits are formed on a substrate in a manufacturing stage. Consequently, data are recorded and a laser beam is irradiated along the pits formed on the substrate, and the amount of reflection of a laser beam is detected by a photo detector. Thus, the recorded data are reproduced.

On the other hand, in recent years, there has been proposed a next generation ROM type optical recording medium having a larger capacity and a high data transfer rate. In such a next generation ROM type optical recording medium, a numerical aperture NA of an objective lens for collecting a laser beam is increased, and furthermore, a wavelength λ of the laser beam is reduced to enhance a recording density.

When the numerical aperture NA of the objective lens for collecting a laser beam is increased, however, there is a problem in that an angle error permitted for the tilt of the optical axis of the laser beam to the optical recording medium, that is, a tilt margin T is greatly reduced as shown in the following equation (1).

$$T = \frac{λ}{d \cdot {NA}^{3}} \qquad ( 1 )$$

In the equation (1), d represents a thickness of a layer through which a laser beam is transmitted until the laser beam reaches the pit formed on the surface of the substrate. As is apparent from the equation (1), the tilt margin T is reduced when the NA of the objective lens is increased, and is increased when the thickness d of the layer through which the laser beam is transmitted is reduced.

Therefore, the next generation ROM type optical recording medium has such a structure that a thin light transmitting layer having a thickness of approximately 100 μm is formed on a substrate and a laser beam is irradiated from the light transmitting layer side to record and reproduce data. Consequently, the tilt margin is enlarged (for example, see JP-A-8-235638 Publication).

In the ROM type optical recording medium, generally, a reflecting layer containing a metal having a high reflectance as a principal component is formed on the substrate in order to increase the reflectance on a laser beam.

However, the metal contained as the principal component in the reflecting layer has a high reflectance on the laser beam and has such a property that it is apt to be corroded by the influence of a foreign matter. In the case in which refuse or dust sticks to the surface of the substrate when the optical recording medium is to be manufactured, accordingly, there is a possibility that the refuse or the dust might be mixed into the reflecting layer and the reflecting layer might be thus corroded while the optical recording medium is stored and used for a long period of time.

Moreover, the reflecting layer contains a metal as a principal component, while the substrate to be the ground of the reflecting layer is formed by a resin and is constituted by a different material from the reflecting layer. Therefore, an adhesion to the reflecting layer tends to be reduced. In such a case, the reflecting layer is peeled from the substrate and a clearance is easily generated between the reflecting layer and the substrate while the optical recording medium is stored and used for a long period of time. For this reason, there is also a possibility that moisture or outside air might come from the clearance and the reflecting layer might be corroded by their influence.

In the case in which the reflecting layer is corroded, thus, the shape of the surface of the reflecting layer is changed or the reflectance is made nonuniform in the plane of the reflecting layer. For this reason, there is a problem in that it is hard to reproduce data as desired.

In particular, the next generation ROM type optical recording medium has such a structure that a laser beam is irradiated from a light transmitting layer side differently from a conventional CD-ROM and DVD-ROM. The laser beam incident on the optical recording medium is reflected by a reflecting layer before reaching the surface of a substrate. For this reason, the shape of the surface of the reflecting layer and the uniformity of a reflectance greatly influence the characteristics of a reproducing signal. Therefore, there is a problem in that it is much more difficult to reproduce data as desired.

### SUMMARY OF THE INVENTION

Accordingly, it is an object of the invention to provide a ROM type optical recording medium which can effectively prevent the corrosion of a reflecting layer and can enhance a reliability in case of storage and use for a long period of time.

In order to achieve the object, the inventors made vigorous and repetitive studies. As a result, it was found that the corrosion resistance of a reflecting layer can be enhanced when nitrogen is added to a reflecting layer containing a metal as a principal component, and the adhesion of the reflecting layer to a substrate can be improved.

The invention is based on the knowledge and can be achieved by a ROM type optical recording medium comprising a substrate, a light transmitting layer, and a reflecting layer formed between the substrate and the light transmitting layer and containing a metal as a principal component, a laser beam being irradiated through the light transmitting layer to reproduce data, wherein at least a part of the substrate side of the reflecting layer contains nitrogen.

In this specification, the containment of the metal as the principal component in the reflecting layer implies that the content of the metal in elements contained in the reflecting layer is the greatest.

According to the invention, the corrosion resistance of the reflecting layer is enhanced. Also in the case in which refuse or dust sticks to the surface of the substrate and is mixed into the reflecting layer when the optical recording medium is to be manufactured, therefore, it is possible to prevent the reflecting layer from being corroded. Furthermore, the adhesion of the reflecting layer to the substrate can be enhanced. Consequently, it is possible to prevent a clearance from being generated between the substrate and the reflecting layer while the optical recording medium is stored and used for a long period of time. Thus, it is possible to prevent the reflecting layer from touching outside air or moisture.

In a preferred embodiment of the invention, a dielectric layer is formed on at least one of surfaces of the reflecting layer by a dielectric material.

According to the invention, the reflecting layer is protected physically and chemically by the dielectric layer. Therefore, even in the case in which moisture enters the optical recording medium while the optical recording medium is stored and used for a long period of time, the dielectric layer cuts off the moisture. Accordingly, it is possible to effectively prevent the moisture from reaching the reflecting layer. Thus, the reflecting layer can be prevented from being corroded still more effectively.

In another preferred embodiment of the invention, the dielectric layers are formed on both surfaces of the reflecting layer. In the case in which the dielectric layers are formed on both surfaces of the reflecting layer, it is possible to protect the reflecting layer more effectively. Thus, it is possible to prevent moisture or outside air from entering the reflecting layer more reliably.

In a further preferred embodiment of the invention, the reflecting layer includes Ag or an alloy containing the Ag as a principal component. In the case in which the reflecting layer includes the Ag or the alloy containing the Ag as the principal component, it is possible to form a reflecting layer having an excellent surface property. Accordingly, it is possible to reduce a noise included in a reproducing signal.

The Ag or the alloy containing the Ag easily reacts to sulfur. In the invention, in the case in which the reflecting layer includes the Ag or the alloy containing the Ag as the principal component, therefore, it is preferable that the dielectric layer should be formed by a dielectric material which substantially contains no sulfur. In this specification, the dielectric material which substantially contains no sulfur implies that the dielectric material does not contain the sulfur except for the case in which the sulfur is contained as an impurity.

Moreover, the object of the invention can be achieved by a ROM type optical recording medium comprising a substrate, a light transmitting layer, and at least two reflecting layers laminated between the substrate and the light transmitting layer through an intermediate layer and containing a metal as a principal component, a laser beam being irradiated through the light transmitting layer to reproduce data, wherein at least a part of an opposite side to a light incidence plane of at least one of the two reflecting layers or more contains nitrogen.

In a preferred embodiment of the invention, at least a part of an opposite side to the light incidence plane of any of the two reflecting layers or more which is the closest to the substrate contains nitrogen.

In a further preferred embodiment of the invention, a dielectric layer is formed on at least one of surfaces of at least one of the two reflecting layers or more by a dielectric material.

According to the invention, it is possible to provide a ROM type optical recording medium which can effectively prevent the corrosion of a reflecting layer and can enhance a reliability in case of storage and use for a long period of time.

### BRIEF DESCRIPTION OF THE DRAWINGS

FIG. 1 is a schematic perspective view showing an optical recording medium according to a preferred embodiment of the invention,

FIG. 2 is a schematic enlarged sectional view showing a portion indicated as A in FIG. 1,

FIG. 3 is a schematic perspective view showing the surface of a substrate,

FIG. 4 is a schematic enlarged sectional view taken along an axis X-X in FIG. 3, illustrating the sectional shapes of the surface of the substrate and that of a reflecting layer,

FIG. 5 is a schematic enlarged sectional view showing an optical recording medium according to another preferred embodiment of the invention,

FIG. 6 is a schematic enlarged sectional view showing an optical recording medium according to a further preferred embodiment of the invention, and

FIG. 7 is a schematic enlarged sectional view showing an optical recording medium according to a further preferred embodiment of the invention.

### DETAILED DESCRIPTION OF THE PREFERRED EMBODIMENTS

Preferred embodiments of the invention will be described below in detail with reference to the accompanying drawings.

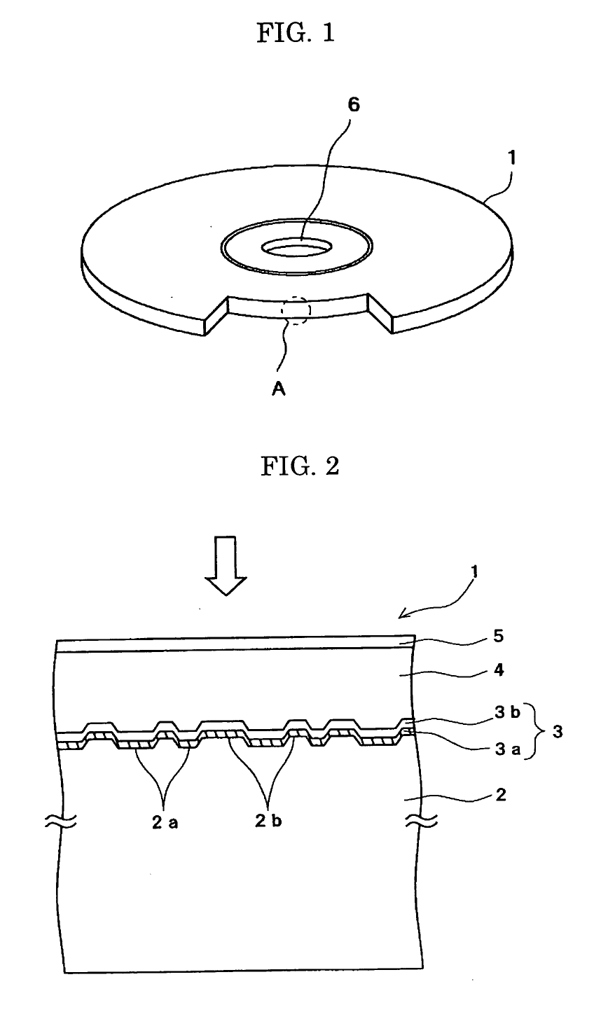

FIG. 1 is a schematic perspective view showing a ROM type optical recording medium according to a preferred embodiment of the invention, and FIG. 2 is a schematic enlarged sectional view showing a portion indicated as A in FIG. 1.

As shown in FIG. 1, an optical recording medium 1 takes the shape of a disk and has a central portion on which a center hole 6 for setting the optical recording medium 1 into a data reproducing device is formed.

The optical recording medium 1 shown in FIGS. 1 and 2 has such a structure that a laser beam having a wavelength of 380 nm to 450 nm is irradiated through an objective lens (not shown) having a numerical aperture NA to satisfy λNA≦640 nm in a direction shown in an arrow in FIG. 2 so that data are reproduced.

As shown in FIG. 2, the optical recording medium 1 according to the embodiment comprises a substrate 2, a reflecting layer 3 formed on the substrate 2, a light transmitting layer 4 formed on the reflecting layer 3, and a hard coat layer 5 formed on the light transmitting layer 4.

The substrate 2 functions as the mechanical support of the optical recording medium 1.

A material for forming the substrate 2 which can function as the support of the optical recording medium 1 is not particularly restricted but a polycarbonate resin and an olefin resin can be used, for example. The thickness of the substrate 2 is not particularly restricted but is preferably approximately 1.1 mm.

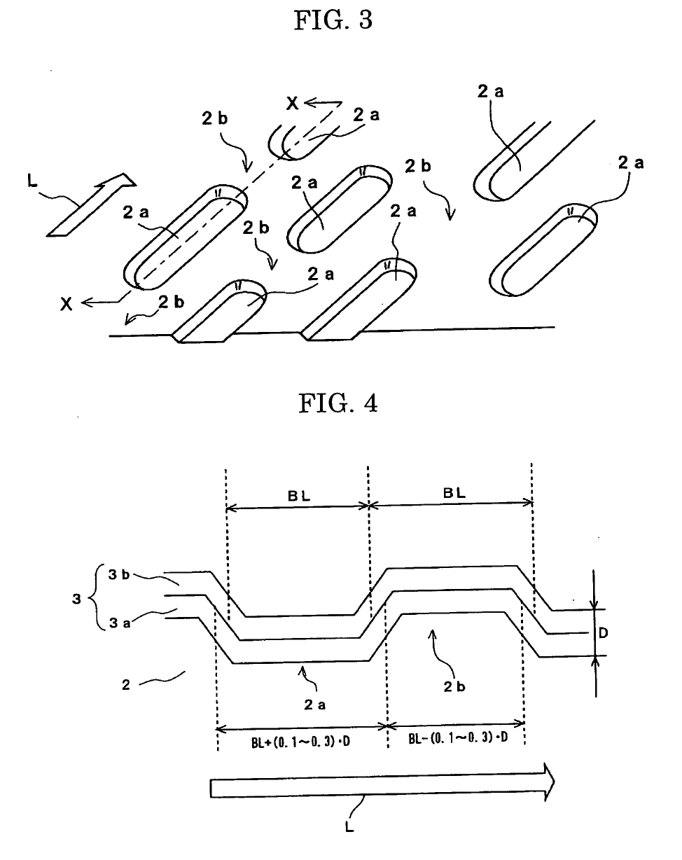

FIG. 3 is a schematic perspective view showing the surface of the substrate 2. In FIG. 3, an arrow L indicates the scan direction of a laser beam.

As shown in FIG. 3, a plurality of concave pits 2a taking an almost elliptical shape is formed on the surface of the substrate 2. The concave pits 2a are formed spirally from an inner peripheral side toward an outer peripheral side in the optical recording medium 1 or from the outer peripheral side toward the inner peripheral side, thereby constituting a track. Moreover, a region other than the concave pits 2a is formed flatly to constitute a space 2b. “0” or “1” of digital data is caused to correspond to the concave pit 2a and the space 2b between the concave pits 2a which are adjacent to each other in a tracking direction respectively, and the data are recorded by the concave pit 2a and the space 2b.

FIG. 4 is a schematic enlarged sectional view taken along X-X in FIG. 3, illustrating the sectional shapes of the surface of the substrate 2 and the surface of the reflecting layer 3 which will be described below. In FIG. 4, an arrow L indicates the scan direction of a laser beam.

In the embodiment, the concave pit 2a to be formed on the surface of the substrate 2 is provided to be longer than a basic length BL by a length of (0.1 to 0.3)·D, while the space 2b between the concave pits 2a which are adjacent to each other in the tracking direction is formed to be shorter than the basic length BL by the length of (0.1 to 0.3)·D.

D represents a distance from the surface of the reflecting layer 3 to that of the substrate 2, that is, the thickness of the reflecting layer 3 in the embodiment. Moreover, the basic length BL is determined corresponding to the number of bits of “0” or “1” of data to be recorded and has seven lengths of 149 nm, 223.5 nm, 298 nm, 372.5 nm, 447 nm, 521.5 nm and 596 nm corresponding to 2T to 8T in the case in which data 2T to 8T modulated by a 1-7RLL modulation are to be recorded on the optical recording medium 1 in a recording capacity of 25 GB, for example.

In the optical recording medium 1 having such a structure that a laser beam is irradiated from the light transmitting layer 4 side, when data recorded on the optical recording medium 1 are to be reproduced, the laser beam incident on the optical recording medium 1 is reflected by the reflecting layer 3 before reaching the surface of the substrate 2. For this reason, a reproducing signal generated by a photodetector does not correspond to the shape of the surface of the substrate 2 but mainly to the shape of the surface of the reflecting layer 3. The lengths of a concave portion formed on the reflecting layer 3 and a clearance between adjacent concave portions to each other in the tracking direction are different from the lengths of the concave pit 2a and the space 2b on the surface of the substrate 2. For this reason, the jitter characteristic of the reproducing signal is deteriorated.

In the case in which the concave pit 2a and the space 2b on the surface of the substrate 2 are formed to have the lengths, however, the lengths of the concave portion formed on the reflecting layer 3 and the clearance between the concave portions can be set to be almost equal to the basic length BL to be a length corresponding to data to be recorded. Thus, it is possible to obtain a reproducing signal having an excellent jitter characteristic.

As shown in FIG. 2, the reflecting layer 3 is formed on the substrate 2.

The reflecting layer 3 has the function of reflecting a laser beam incident through the hard coat layer 5 and the light transmitting layer 4 and emitting the laser beam from the hard coat layer 5 side again.

In the embodiment, the reflecting layer 3 includes a second reflecting film 3a formed on the substrate 2 and a first reflecting film 3b formed on the second reflecting film 3a.

The second reflecting film 3a contains a metal as a principal component and nitrogen is added as an additive thereto.

According to the studies of the inventor, it has been found that the corrosion resistance of the second reflecting film 3a can be enhanced and the adhesion of the second reflecting film 3a to the substrate 2 can be improved in the case in which the nitrogen is added as the additive. Also in the case in which refuse or dust sticks to the surface of the substrate 2 and is mixed into the reflecting layer 3 when the optical recording medium 1 is to be manufactured, accordingly, it is possible to prevent the corrosion of the second reflecting film 3a and that of the whole reflecting layer 3. Furthermore, the adhesion of the second reflecting film 3 a to the substrate 2 can be enhanced. Therefore, it is possible to prevent a clearance from being generated between the substrate 2 and the reflecting layer 3 while storing and using the optical recording medium 1 for a long period of time. Thus, it is possible to prevent the reflecting layer 3 from touching outside air or moisture.

The metal contained as the principal component in the second reflecting film 3 which can reflect the laser beam is not particularly restricted and it is possible to use at least one metal selected from the group consisting of Mg, Al, Ti, Cr, Fe, Co, Ni, Cu, Zn, Ge, Pt, Au, Ag, Pd, Nd, In, Sn and Bi or their alloy. In the case in which the second reflecting film 3a is formed to include Ag or an alloy containing the Ag as a principal component, it is possible to form the second reflecting film 3a having a high reflectance and an excellent flatness of the surface, which is preferable.

In the embodiment, the amount of the nitrogen to be added to the second reflecting film 3a is preferably 0.5 to 10 atomic % and is more preferably 1 to 5 atomic %.

In the case in which the amount of the nitrogen to be added to the second reflecting film 3a is less than 0.5 atomic %, there is a possibility that a sufficient corrosion resistance might not be obtained. On the other hand, in the case in which the same amount exceeds 10 atomic %, there is a possibility that the flatness of the surface of the second reflecting film 3a might be remarkably deteriorated, resulting in a great increase in a noise included in a reproducing signal.

The thickness of the second reflecting film 3a is not particularly restricted but is preferably 5 nm to 50 nm and is more preferably 10 nm to 50 nm. There is a drawback that it is hard to sufficiently increase an adhesion to the substrate 2 if the thickness of the second reflecting film 3a is smaller than 5 nm, while the flatness of the surface of the second reflecting film 3a is apt to be deteriorated if the thickness of the second reflecting film 3a is greater than 50 nm.

The first reflecting film 3b is formed to contain a metal as a principal component and the nitrogen is not added thereto differently from the second reflecting film 3a.

In the case in which the nitrogen is added to the reflecting film, the flatness of the surface of the reflecting film is deteriorated. Consequently, there is a possibility that a noise included in the reproducing signal might be increased. When the first reflecting film 3b having no nitrogen added thereto is formed on the second reflecting film 3a having the nitrogen added thereto, the reflecting layer 3 having an excellent flatness of the surface can be formed. Thus, it is possible to enhance the corrosion resistance of the reflecting layer 3 without increasing a noise component included in the reproducing signal, and furthermore, to improve the adhesion to the substrate 2.

The metal contained as the principal component in the first reflecting film 3b which can reflect the laser beam is not particularly restricted but the same metal as that contained as the principal component in the second reflecting film 3a can be used. It is preferable that the first reflecting film 3b should include Ag or an alloy containing the Ag as a principal component in the same manner as the second reflecting film 3a.

The thickness of the first reflecting film 3b is not particularly restricted but is preferably 10 nm to 200 nm and is more preferably 20 nm to 100 nm in respect of the reflectance and film forming property of the first reflecting film 3b.

The light transmitting layer 4 causes a laser beam to be transmitted therethrough, and at the same time, functions as a protecting layer for protecting the surface of the reflecting layer 3.

The light transmitting layer 4 is optically transparent and is required to have a small optical absorption and reflection and a small double refraction in the wavelength region of a laser beam to be used, that is, a range of 380 nm to 450 nm and is formed by an ultraviolet curing resin, for example.

The ultraviolet curing resin to be used for forming the light transmitting layer 4 contains a photopolymerizing monomer, a photopolymerizing oligomer, a photoinitiator and other additives as desired. A monomer having a molecular weight of less than 2000 is suitable for the photopolymerizing monomer and examples of the photopolymerizing monomer include monofunctional (meth)acrylate and multifunctional (meth)acrylate. Moreover, examples of the photopolymerizing oligomer include an oligomer containing or introducing, in a molecule, a group to be crosslinked or polymerized by an ultraviolet irradiation such as an acrylic double bond, an allylic double bond or an unsaturated double bond. Furthermore, any well-known photoinitiator may be used, and a molecule cleavage type photopolymerizing initiator can be used for the photoinitiator, for example.

It is preferable that the light transmitting layer 4 should have a thickness of 30 μm to 200 μm.

Moreover, the light transmitting layer 4 is a layer through which a laser beam is transmitted. For this reason, an optical characteristic such as a refractive index is required to be almost uniform in the plane. Accordingly, it is preferable that the light transmitting layer 4 should be formed to have an almost equal thickness. More specifically, it is preferable that a variation in a thickness in the plane should be ±5% or less.

In the case in which the variation in the thickness of the light transmitting layer 4 is greater than ±5%, the optical characteristic in the plane of the light transmitting layer 4 becomes nonuniform. For this reason, it is hard to accurately cause the laser beam to follow the pit 2a. Consequently, there is a possibility that the recorded data might not be reproduced as desired.

The hard coat layer 5 functions to physically protect the light transmitting layer 4 and to prevent the light transmitting layer 4 from being damaged.

A material for forming the hard coat layer 5 is not particularly restricted but a material which is excellent in a light permeability and an abrasion resistance is preferable. It is preferable that the hard coat layer 5 should be formed by a hard coat agent composition in which an inorganic particle having an average particle diameter of 100 nm or less is added to an active energy line curing resin.

The thickness of the hard coat layer 5 is preferably 1 μm to 10 μm and is more preferably 1 μm to 5 μm. In the case in which the thickness of the hard coat layer 5 is smaller than 1 μm, there is a possibility that a hardness or an abrasion resistance which is required for the hard coat layer 5 cannot be satisfied. On the other hand, in the case in which the same thickness is greater than 10 μm, there is a possibility that a crack might be generated on the hard coat layer 5 by an internal stress.

The optical recording medium 1 having the above structure is manufactured in the following manner.

First of all, the substrates having the pit 2a is formed on one of surfaces through injection molding by using a stamper.

Subsequently, the second reflecting film 3a is formed on the surface of the substrate 2 provided with the pit 2a. In the embodiment, the second reflecting film 3a is formed by a sputtering method using a mixed gas of an argon gas and a nitrogen gas as a sputtering gas and utilizing a metal as a target. As a result, the second reflecting film 3a contains a metal as a principal component and has a composition to which nitrogen is added as an additive. When the second reflecting film 3a is to be formed, the content of the nitrogen in the second reflecting film 3a is regulated by the control of the rate of the nitrogen gas in the sputtering gas.

When the second reflecting film 3a is formed, the first reflecting film 3b is formed on the second reflecting film 3a. When the first reflecting film 3b is to be formed, the first reflecting film 3a is formed by the sputtering method using an argon gas as a sputtering gas and utilizing a metal as a target differently from a second dielectric layer 23a.

Subsequently, the first reflecting film 3a is coated with an ultraviolet curing resin by a spin coating method so that a coated film is formed, and the ultraviolet rays are irradiated on the coated film so that the ultraviolet curing resin is cured and the light transmitting layer 4 is thus formed.

Finally, the light transmitting layer 4 is coated with an active energy line curing resin and a hard coat agent composition containing an inorganic particulate by the spin coating method so that the coated film is formed, and an active energy line is irradiated on the coated film so that the hard coat layer 5 is formed.

According to the embodiment, the second reflecting film 3a to come in contact with the substrate 2 contains a metal as a principal component and the nitrogen is added as an additive. Therefore, it is possible to enhance the corrosion resistance of the reflecting layer 3 and to improve the adhesion of the reflecting layer 3 to the substrate 2. Accordingly, it is possible to effectively prevent the corrosion of the reflecting layer 3 and to enhance a reliability in case of storage and use for a long period of time.

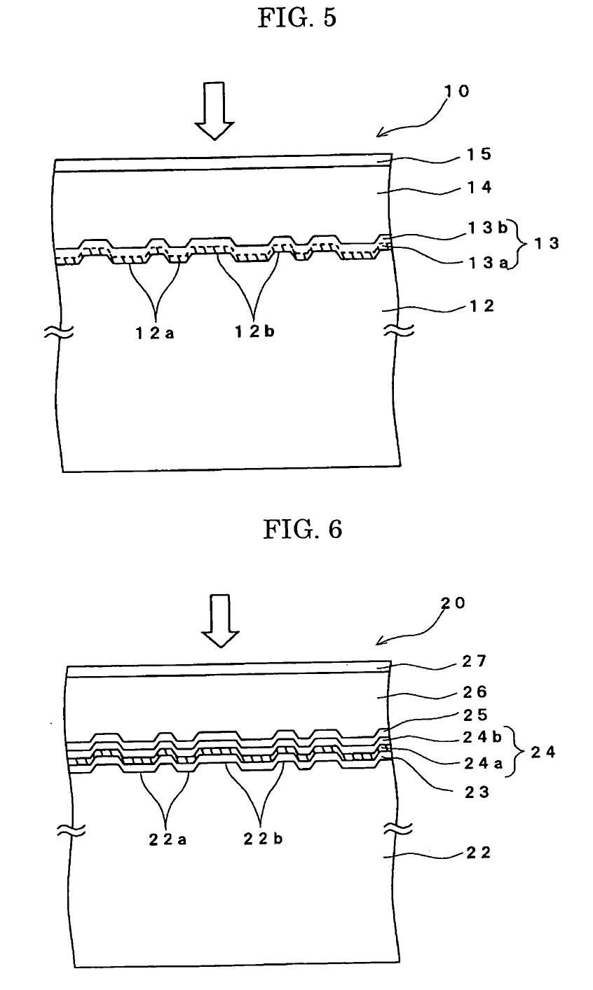

FIG. 5 is a schematic enlarged sectional view showing an optical recording medium according to another preferred embodiment of the invention.

As shown in FIG. 5, an optical recording medium 10 according to the embodiment comprises a substrate 12, a reflecting layer 13 formed on the substrate 12, a light transmitting layer 14 formed on the reflecting layer 13, and a hard coat layer 15 formed on the light transmitting layer 14, and has the same structure as that of the optical recording medium 1 shown in FIG. 2 except that the reflecting layer 13 has a single layer structure.

In the same manner as the reflecting layer 3 shown in FIG. 2, the reflecting layer 13 has the function of reflecting a laser beam incident through the hard coat layer 15 and the light transmitting layer 14 and emitting the laser beam from the hard coat layer 15 side again.

In the embodiment, the reflecting layer 13 is formed to contain a metal as a principal component.

The metal contained as the principal component in the reflecting film 13 which can reflect the laser beam is not particularly restricted. In the same manner as the first reflecting film 3b and the second reflecting film 3a shown in FIGS. 1 and 2, it is possible to use at least one metal selected from the group consisting of Mg, Al, Ti, Cr, Fe, Co, Ni, Cu, Zn, Ge, Pt, Au, Ag, Pd, Nd, In, Sn and Bi or their alloy. Among them, it is preferable that the Ag or an alloy containing the Ag should be used.

In the embodiment, moreover, the reflecting layer 13 is formed to have different compositions in a region on a close side to the substrate 12 and a region on a close side to the light transmitting layer 14 as shown in FIG. 5, and nitrogen is added as an additive to a second region 13a on a close side to the substrate 12 and the nitrogen is not added to a first region 13b on a close side to the light transmitting layer 14.

The content of the nitrogen to be added to the second region 13a is preferably 0.5 to 10 atomic % and is more preferably 1 to 5 atomic % in the same manner as the second reflecting film 3a shown in FIG. 2.

The thickness of the reflecting layer 13 is not particularly restricted but is preferably 15 nm to 200 nm and is more preferably 20 nm to 100 nm in respect of the reflectance and film forming property of the reflecting layer 13.

The optical recording medium 10 having the above structure is manufactured in the following manner.

First of all, the substrate 12 is formed by injection molding and the reflecting layer 13 is then formed on the surface of the substrate 12.

In the embodiment, in order to form the reflecting layer 13, a thin film is first formed by a sputtering method using a mixed gas of an argon gas and a nitrogen gas as a sputtering gas and utilizing a metal as a target so that the second region 13a having the nitrogen added thereto is formed. Thereafter, the supply of only the nitrogen gas is stopped and the first region 13b having no nitrogen added thereto is formed on the surface of the second region 13a.

Subsequently, the light transmitting layer 14 and the hard coat layer 15 are sequentially formed on the surface of the reflecting layer 13 by a spin coating method so that the optical recording medium 10 is finished.

According to the embodiment, the nitrogen is added as the additive to the second region 13a of the reflecting layer 13. Therefore, it is possible to enhance the corrosion resistance of the reflecting layer 13 and to improve the adhesion of the reflecting layer 13 to the substrate 12. Also in the case in which refuse or dust sticks to the surface of the substrate 12 and is mixed into the reflecting layer 13 when the optical recording medium 10 is to be manufactured, accordingly, it is possible to prevent the corrosion of the reflecting layer 13. Furthermore, the adhesion of the reflecting layer 13 to the substrate 12 can be enhanced. Therefore, it is possible to prevent a clearance from being generated between the substrate 12 and the reflecting layer 13 while storing and using the optical recording medium 10 for a long period of time. Thus, it is possible to prevent the reflecting layer 13 from touching outside air or moisture.

FIG. 6 is a schematic enlarged sectional view showing an optical recording medium according to yet another embodiment of the invention.

As shown in FIG. 6, an optical recording medium 20 according to the embodiment comprises a substrate 22, a second dielectric layer 23 formed on the substrate 22, a reflecting layer 24 formed on the second dielectric layer 23, a first dielectric layer 25 formed on the reflecting layer 24, a light transmitting layer 26 formed on the first dielectric layer 25, and a hard coat layer 27 formed on the light transmitting layer 26, and has the same structure as that of the optical recording medium 1 shown in FIG. 2 except that the first dielectric layer 25 and the second dielectric layer 23 are formed on both surface sides of the reflecting layer 24.

The reflecting layer 24 has the same structure as that of the reflecting layer 3 shown in FIG. 2 and contains a metal as a principal component, and includes a second reflecting film 24a having nitrogen added thereto and a first reflecting film 24b containing a metal as a principal component and having no nitrogen added thereto.

The first dielectric layer 25 and the second dielectric layer 23 function to protect the reflecting layer 24 physically and chemically. Moreover, the first dielectric layer 25 and the second dielectric layer 23 play a part in enhancing the adhesion of the reflecting layer 24 to the substrate 22 and the light transmitting layer 26 by the fixation of the first dielectric layer 25 to the light transmitting layer 26 and the reflecting layer 24 and that of the second dielectric layer 23 to the substrate 22 and the reflecting layer 24.

In the embodiment, both the first dielectric layer 25 and the second dielectric layer 23 are formed by dielectric materials.

The dielectric materials for forming the first dielectric layer 25 and the second dielectric layer 23 are not particularly restricted but it is possible to use a dielectric material formed of an oxide, a nitride, a sulfide or a fluoride containing at least one metal selected from the group consisting of Si, Al, Ta, Ti, Co, Zr, Pb, Ag, Zn, Sn, Ca, Ce, V, Cu, Fe and Mg or their composite.

In the case in which the reflecting layer 24 is formed to contain the Ag or an alloy containing the Ag as a principal component, however, the Ag or the alloy containing the Ag easily reacts to sulfur to form a sulfide. For this reason, it is preferable that the first dielectric layer 25 and the second dielectric layer 23 should be formed by dielectric materials which substantially contain no sulfur.

The thickness of the first dielectric layer 25 is preferably 5 nm to 100 nm and is more preferably 10 nm to 50 nm. In the case in which the thickness of the first dielectric layer 25 is smaller than 5 nm, it is hard to sufficiently fulfill the function of a protecting film. On the other hand, in the case in which the same thickness is greater than 100 nm, a long time is required for forming a film so that a productivity might be deteriorated.

Moreover, the thickness of the second dielectric layer 23 is preferably 10 nm to 150 nm and is more preferably 20 nm to 100 nm. In the case in which the thickness of the first dielectric layer 25 is smaller than 10 nm, it is hard to sufficiently fulfill the function of a protecting film. On the other hand, in the case in which the same thickness is greater than 150 nm, a long time is required for forming a film so that a productivity might be deteriorated.

The first dielectric layer 25 and the second dielectric layer 23 can be formed by a sputtering method.

According to the embodiment, the reflecting layer 24 is protected physically and chemically by the first dielectric layer 25 and the second dielectric layer 23. Also in the case in which moisture enters the optical recording medium 20 through the substrate 22 and the light transmitting layer 24 while the optical recording medium 20 is stored and used for a long period of time, therefore, the moisture is cut off by the first dielectric layer 25 and the second dielectric layer 23. Consequently, it is possible to effectively prevent the water from reaching the reflecting layer 24.

According to the embodiment, moreover, the adhesion of the reflecting layer 24 to the substrate 22 and the light transmitting layer 26 is enhanced by the first dielectric layer 25 and the second dielectric layer 23. Therefore, it is possible to prevent a clearance from being generated between the substrate 22 and the reflecting layer 24 and between the light transmitting layer 26 and the reflecting layer 24. Thus, the corrosion of the reflecting layer 24 can be prevented still more effectively.

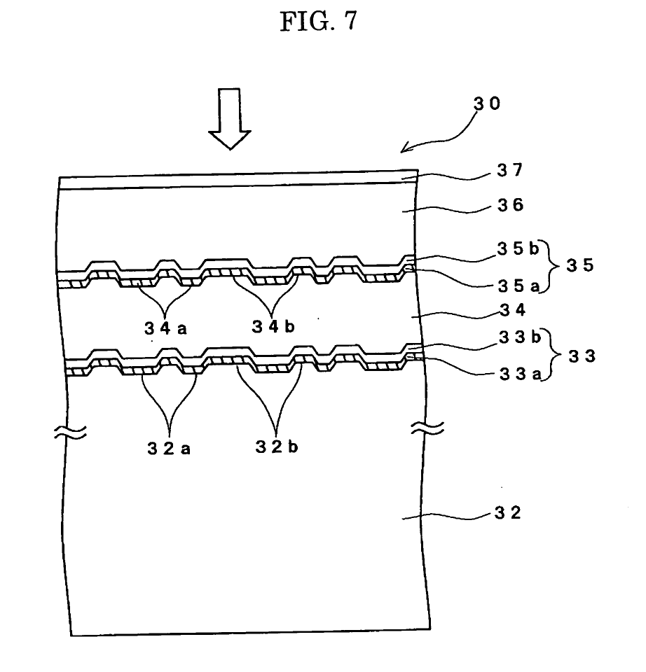

FIG. 7 is a schematic enlarged sectional view showing an optical recording medium according to a further preferred embodiment of the invention.

As shown in FIG. 7, an optical recording medium 30 according to the embodiment comprises a substrate 32, a second reflecting layer 33 formed on the substrate 32, an intermediate layer 34 formed on the second reflecting layer 33, a first reflecting layer 35 formed on the intermediate layer 34, a light transmitting layer 36 formed on the first reflecting layer 35, and a hard coat layer 37 formed on the light transmitting layer 36, and two layers, that is, the reflecting layers 33 and 35 are formed through the intermediate layer 34.

In the embodiment, the second reflecting layer 33 has the same structure as that of the reflecting layer 3 shown in FIG. 2 and contains a metal as a principal component, and includes a second reflecting film 33a having nitrogen added thereto and a first reflecting film 33b containing a metal as a principal component and having no nitrogen added thereto.

The intermediate layer 34 has the function of separating the first reflecting layer 35 and the second reflecting layer 33 from each other physically and optically at a sufficient distance.

As shown in FIG. 7, a concave pit 34a is formed on the surface of the intermediate layer 34.

In the embodiment, the concave pit 34a to be formed on the surface of the intermediate layer 34 and a space 34b between the adjacent concave pits 34a in a tracking direction are provided to be longer than a basic length BL by a length of (0.1 to 0.3)·D and are formed to be shorter than the basic length BL by the length of (0.1 to 0.3)·D respectively in the same manner as the concave pit 2a and the space 2b on the surface of the substrate 2 shown in FIG. 2.

D represents a distance from the surface of the first reflecting layer 35 to that of the intermediate layer 34, that is, the thickness of the first reflecting layer 35 in the embodiment. Moreover, the basic length BL is determined corresponding to the number of bits of “0” or “1” of data to be recorded in the same manner as the basic length BL according to the embodiment shown in FIG. 2.

The intermediate layer 34 is preferably formed to have a thickness of 5 μm to 50 μm and more preferably 10 μm to 40 μm.

The intermediate layer 34 is to have a high transmittance in order to transmit a laser beam therethrough and is preferably formed by a material having a high light permeability with respect to the laser beam. For example, the intermediate layer 34 can be formed by an ultraviolet curing acrylic resin.

The first reflecting layer 35 plays a part in reflecting a laser beam irradiated on the surface of the intermediate layer 34 through the hard coat layer 37 and the light transmitting layer 36 and emitting the laser beam from the hard coat layer 37 side again.

In the same manner as the second reflecting layer 33, the first reflecting layer 35 includes a second reflecting film 35a containing a metal as a principal component and having nitrogen added thereto, and a first reflecting film 35b containing a metal as a principal component and having no nitrogen added thereto.

The first reflecting layer 35 has the function of reflecting a laser beam in the case in which data recorded on the surface of the intermediate layer 34 are to be reproduced. For this reason, the first reflecting layer 35 is to have some reflectance with respect to the laser beam. On the other hand, the first reflecting layer 35 is to have a high light transmittance with respect to the laser beam in order to transmit the laser beam therethrough in the case in which data recorded on the surface of the substrate 32 are to be reproduced.

Accordingly, it is preferable that the first reflecting layer 35 should be formed more thinly than the second reflecting layer 33. More specifically, the thickness of the first reflecting layer 35 is preferably 5 nm to 35 nm and is more preferably 10 nm to 30 nm.

The optical recording medium 30 having the above structure is manufactured in the following manner.

First of all, the substrate 32 having a pit 32a is formed on one of surfaces through injection molding by using a stamper.

In the same manner as the formation of the reflecting layer 3 shown in FIG. 2, subsequently, the second reflecting layer 33a and the first reflecting film 33b are sequentially formed by a sputtering method over almost the whole surface of the substrate 32 provided with the pit 32a, and the second reflecting layer 33 is thus formed.

Furthermore, the surface of the second reflecting layer 33 is coated with an ultraviolet curing acrylic resin by a spin coating method so that a coated film is formed, and the intermediate layer 34 provided with the pit 34a is formed on the surface by the irradiation of ultraviolet rays through the stamper with the surface of the coated film covered with the stamper.

In the same manner as the formation of the second reflecting layer 33, next, the second reflecting film 35a and the first reflecting film 35b are sequentially formed on the surface of the intermediate layer 34 by a sputtering method so that-the first reflecting layer 35 is formed.

Finally, the light transmitting layer 36 and the hard coat layer 37 are sequentially formed on the surface of the first reflecting layer 35 by the spin coating method so that the optical recording medium 30 is finished.

According to the embodiment, the second reflecting film 33a of the second reflecting layer 33 which comes in contact with the substrate 32 contains a metal as a principal component and has nitrogen added as an additive thereto. Therefore, it is possible to enhance the corrosion resistance of the second reflecting layer 33 and to improve the adhesion of the second reflecting layer 33 to the substrate 32. Furthermore, the second reflecting film 35a of the first reflecting layer 35 which comes in contact with the intermediate layer 34 contains a metal as a principal component and has the nitrogen added as the additive thereto. Therefore, it is possible to enhance the corrosion resistance of the first reflecting layer 35 and to improve the adhesion of the first reflecting layer 35 to the intermediate layer 34.

Also in the case in which refuse or dust sticks to the surfaces of the substrate 32 and the intermediate layer 34 and is mixed into the first reflecting layer 35 and the second reflecting layer 33 when the optical recording medium 30 is to be manufactured, accordingly, it is possible to prevent the corrosion of the first reflecting layer 35 and the second reflecting layer 33. Furthermore, it is possible to enhance both the adhesion of the substrate 32 to the second reflecting layer 33 and that of the intermediate layer 34 to the first reflecting layer 35. Therefore, it is possible to prevent a clearance from being generated between the substrate 32 and the second reflecting layer 33 and between the intermediate layer 34 and the first reflecting layer 35 while storing and using the optical recording medium 30 for a long period of time. Thus, it is possible to prevent the first reflecting layer 35 and the second reflecting layer 33 from touching outside air or moisture.

The invention is not restricted to the above embodiments but it is apparent that various changes can be made without departing from the scope of the invention described in the claims and are included within the scope of the invention.

For example, in the optical recording media 1, 20 and 30 shown in FIGS. 2, 6 and 7, the nitrogen is added to the whole second reflecting films 3a, 23a, 33a and 35a. In the optical recording medium 10 shown in FIG. 5, the nitrogen is added to the whole second region 13a. If the corrosion resistance of the reflecting layer can be enhanced and the adhesion of the substrate to the intermediate layer can be improved, however, it is not necessary to add the nitrogen to a whole contact surface with the substrate or the intermediate layer.

In the optical recording media 1, 20 and 30 shown in FIGS. 2, 6 and 7, moreover, the reflecting layers 3, 23, 33 and 35 include the first reflecting film and the second reflecting film and are thus formed by the reflecting films having two layers. The reflecting layers 3, 23, 33 and 35 do not need to be formed by the two reflecting films. If the reflecting film having the nitrogen added thereto is formed in the closest position to the substrate, the reflecting layer may be constituted by the reflecting films having three layers or more.

While the reflecting layers 23, 33 and 35 include the first reflecting film and the second reflecting film and are thus formed by the reflecting films having two layers in the optical recording media 20 and 30 shown in FIGS. 6 and 7, furthermore, the reflecting layers 23, 33 and 35 may be formed by a reflecting layer having a single layer structure including a second region having nitrogen added thereto and a first region having no nitrogen added thereto in place of the reflecting film having the two layers.

While the first dielectric layer 25 and the second dielectric layer 23 are provided on both sides of the reflecting layer 24 in the optical recording medium 20 shown in FIG. 6, moreover, the dielectric layer does not need to be provided on both sides of the reflecting layer 24 but may be formed on at least one of the surfaces of the reflecting layer 24.

While the two reflecting layers constituted by the first reflecting layer 35 and the second reflecting layer 33 are provided in the optical recording medium 30 shown in FIG. 7, furthermore, the invention is not restricted to a ROM type optical recording medium having the two reflecting layers but can be applied to a ROM type optical recording medium having three reflecting layers or more.

While each of the first reflecting layer 35 and the second reflecting layer 33 includes the second reflecting film and the first reflecting film and the nitrogen is added to an opposite side to the light incidence plane of the reflecting layer in the optical recording medium 30 shown in FIG. 7, moreover, the nitrogen does not need to be added to both the first reflecting layer 35 and the second reflecting layer 33 but may be added to one of the first reflecting layer 35 and the second reflecting layer 33. In a manufacturing stage, foreign matters such as refuse and dust which stick to the surface of the substrate 2 mainly cause the corrosion of the reflecting layer. In the case in which the nitrogen is to be added to only one of the first reflecting layer 35 and the second reflecting layer 33, therefore, it is preferable that the nitrogen should be added to the second reflecting layer 33 which is the closest to the substrate 2.

While the first reflecting layer 35 and the second reflecting layer 33 are formed to come in contact with the substrate 32, the intermediate layer 34 and the light transmitting layer 36 in the optical recording medium 30 shown in FIG. 7, furthermore, this is not restricted but the dielectric layer may be formed on at least one of the surfaces of both or either of the first reflecting layer 35 and the second reflecting layer 33.

While the concave pits 2a, 12a, 22a, 32a and 34a are formed on the surfaces of the substrates 2, 12, 22 and 32 and the intermediate layer 34 in the optical recording media 1, 10, 20 and 30 shown in FIGS. 2 to 7, moreover, a plurality of concave pits does not need to be provided on the surfaces of the substrate and the intermediate layer to form a pit and a space but a plurality of convex portions having an almost elliptical shape may be provided on the surfaces of the substrate and the intermediate layer to form a convex pit and a space. In such a case, a concavo-convex relationship between the substrate and intermediate layer which have the concave pits formed on the surfaces and the pit and space is reversed. For this reason, the convex pit is formed to be shorter than the basic length BL by the length of (0.1 to 0.3)·D, while the space between the convex pits which are adjacent to each other in the tracking direction is formed to be longer than the basic length BL by the length of (0.1 to 0.3)·D.

While the hard coat layers 5, 15, 25 and 37 are provided on the surfaces of the light transmitting layers 4, 14, 24 and 36 in the optical recording media 1, 10, 20 and 30 shown in FIGS. 2, 5, 6 and 7, furthermore, the hard coat layers do not need to be provided on the surfaces of the light transmitting layers and can also be omitted in the case in which the light transmitting layers have a high resistance to a damage or an abrasion.

What is claimed is:

1. A ROM type optical recording medium comprising:
a substrate;
a light transmitting layer; and
a reflecting layer formed between the substrate and the light transmitting layer and containing a metal as a principal component,
wherein a laser beam is irradiated through the light transmitting layer to reproduce data, and
wherein at least a part of the substrate side of the reflecting layer contains nitrogen.

2. The ROM type optical recording medium according to claim 1, wherein a dielectric layer is formed on at least one of surfaces of the reflecting layer by a dielectric material.

3. The ROM type optical recording medium according to claim 2, wherein the dielectric layer is also formed on the other surface of the reflecting layer.

4. The ROM type optical recording medium according to claim 2, wherein the reflecting layer includes Ag or an alloy containing the Ag as a principal component.

5. The ROM type optical recording medium according to claim 4, wherein the dielectric layer is formed by a dielectric material which substantially contains no sulfur.

6. The ROM type optical recording medium according to claim 1, wherein an amount of nitrogen to be added to the reflecting layer is 0.5 to 10 atomic %.

7. The ROM type optical recording medium according to claim 1, wherein the reflecting layer is constituted by a first reflecting film containing no nitrogen and a second reflecting film containing the nitrogen.

8. The ROM type optical recording medium according to claim 7, wherein the first reflecting film has a thickness of 10 nm to 200 nm.

9. The ROM type optical recording medium according to claim 7, wherein the second reflecting film has a thickness of 5 nm to 50 nm.

10. A ROM type optical recording medium comprising:
a substrate;
a light transmitting layer; and
at least two reflecting layers laminated between the substrate and the light transmitting layer through an intermediate layer and containing a metal as a principal component,
wherein a laser beam being irradiated through the light transmitting layer to reproduce data, and
wherein at least a part of an opposite side to a light incidence plane of at least one of the two reflecting layers or more contains nitrogen.

11. The ROM type optical recording medium according to claim 10, wherein a dielectric layer is formed on at least one of surfaces of at least one of the two reflecting layers or more by a dielectric material.

12. The ROM type optical recording medium according to claim 11, wherein the dielectric layer is also formed on the other surface of the reflecting layer.

13. The ROM type optical recording medium according to claim 11, wherein the reflecting layer includes Ag or an alloy containing the Ag as a principal component.

14. The ROM type optical recording medium according to claim 13, wherein the dielectric layer is formed by a dielectric material which substantially contains no sulfur.

15. The ROM type optical recording medium according to claim 10, wherein an amount of nitrogen to be added to the reflecting layer is 0.5 to 10 atomic %.

16. The ROM type optical recording medium according to claim 10, wherein at least one of the two reflecting layers or more is constituted by a first reflecting film containing no nitrogen and a second reflecting film containing the nitrogen.

17. The ROM type optical recording medium according to claim 16, wherein the first reflecting film has a thickness of 10 nm to 200 nm.

18. The ROM type optical recording medium according to claim 16, wherein the second reflecting film has a thickness of 5 nm to 50 nm.
